(19) United States
(12) Patent Application Publication
(10) Pub. No.: US 2016/0195167 A1
(43) Pub. Date: Jul. 7, 2016

(54) MECHANICAL TRANSMISSION

(71) Applicant: Hofmann Engineering Pty Ltd, Bassendean (AU)

(72) Inventor: Erich John Hofmann, Bassendean (AU)

(73) Assignee: Hofmann Engineering Pty Ltd, Bassendean (AU)

(21) Appl. No.: 14/989,085

(22) Filed: Jan. 6, 2016

(30) Foreign Application Priority Data
Jan. 6, 2015 (AU) 2015900019

(51) Int. Cl. F16H 1/00; B64C 25/40; F16D 3/18; F16H 1/24; F16H 1/04

(52) U.S. Cl. CPC F16H 1/006; F16H 1/24; F16H 1/04; F16D 3/185; B64C 25/405

(57) ABSTRACT

A drive system (10) for an aircraft, operable for selectively enabling ground movement, and in particular taxiing movement, of the aircraft without requiring the aircraft to be moved by a ground vehicle. The drive system (10) comprises a power system (25) and a mechanical transmission (23) for delivering rotational drive to landing gear (13) of the aircraft. The mechanical transmission (23) comprises an input (41) for receiving drive from the power system (25), an output (43) for delivering drive to the landing gear (13), and a gear mechanism (45) operably coupling the input and output to transmit drive from the input to the output. The gear mechanism (45) is configured to accommodate some misalignment between the input (41) and output (43).

### TECHNICAL FIELD

This invention relates to a mechanical transmission for transmission of mechanical power between an input to an output.

This invention also relates to ground movement of an aircraft, for which it has been devised particularly. In this respect, the invention is concerned with ground movements of aircraft using propulsion derived from the aircraft and delivered by way of a mechanical transmission.

### BACKGROUND ART

The following discussion of the background art is intended to facilitate an understanding of the present invention only. The discussion is not an acknowledgement or admission that any of the material referred to is or was part of the common general knowledge as at the priority date of the application.

The invention has been devised particularly, although not necessarily solely, in relation to ground movements of aircraft using propulsion derived from the aircraft and delivered by way of a mechanical transmission. Accordingly, the following discussion in relation to background art is provided in the context of a mechanical transmission for delivery of mechanical power to facilitate ground movement of an aircraft using propulsion derived from the aircraft. However, the invention may have application to mechanical power transmission in various other fields, particularly where there may be a need to accommodate some misalignment between an input and an output.

Ground movement of aircraft of the type which cannot be performed using propulsion derived from the aircraft is normally performed by a ground vehicle coupled to the aircraft, generally to the nose landing gear. The ground movement may involve pushing or pulling of the aircraft using the ground vehicle to effect movement of the aircraft on the ground.

It would be advantageous for there to be a drive system onboard an aircraft selectively enabling ground movement, and in particular taxiing movement, of the aircraft without requiring the aircraft to be moved by a ground vehicle. However, a drive system onboard an aircraft would likely be confronted with challenges arising from loadings and wheel deflection imposed upon landing gear during take-off and landing of the aircraft, particularly at times when the landing wheel moves into and out of contact with the ground surface.

It is against this background that the present invention has been developed.

### SUMMARY OF INVENTION

According to a first aspect of the invention there is provided a drive system for an aircraft, the drive system comprising a power system and a mechanical transmission for delivering rotational drive to landing gear of the aircraft, the mechanical transmission comprising an input for receiving drive from the power system, an output for delivering drive to the landing gear, and a gear mechanism operably coupling the input and output to transmit drive from the input to the output, the gear mechanism being configured to accommodate misalignment between the input and output.

The power system may comprise a power source such as an electric motor. The electric motor may be powered from an auxiliary power unit (APU) onboard the aircraft. The electric motor may be powered from an auxiliary power unit (APU) onboard the aircraft.

The power system may further comprise a gearbox for transmitting drive from the power source to the input of the mechanical transmission.

The gear mechanism may be configured to accommodate angular misalignment between the input and output to an extent up to about 5 degrees.

The gear mechanism may comprise a male external gear and a female internal gear in meshing engagement about the external male gear.

The male gear may be of barrel configuration and the female gear may be of straight configuration. This arrangement facilitates angular movement between the male and female gears which maintaining meshing engagement therebetween. Meshing contact between the male and female gears may be along a line which is arcuate, the line corresponding to the range of angular movement of the output available to accommodate angular misalignment.

The male gear may comprise gear teeth presenting an involute curve profile.

Preferably, the involute curve is constant along the full length of the external male gear.

More particularly, the male gear may comprise gear teeth presenting a rhomboidal lead profile with constant involute profile.

The output may comprise a roller gear adapted to be drivingly coupled to the landing gear. More particularly, the roller gear may be adapted to be drivingly coupled to a landing wheel of the landing gear.

In one arrangement there is provided a sprocket means drivingly coupled to the landing wheel and the roller gear is adapted for meshing engagement with the sprocket means

With the gear mechanism being configured to accommodate misalignment between the input and output, the arrangement allows the roller gear to accommodate some misalignment with respect to the sprocket means. In particular, the roller gear is able to respond to said misalignment by articulating from a normal condition to assume an articulated condition in which the axis of rotation of the roller gear is in effect parallel to the axis of rotation of the sprocket means to thereby achieve effective driving engagement with the sprocket means.

The output may further comprise a hub incorporating the roller gear.

The hub may be supported on spherical bearings allowing angular displacement of the roller gear. Each spherical bearing may comprises an inner bearing member having an outer convex spherical bearing surface, and an outer bearing member having an inner concave spherical bearing surface, with the outer and inner spherical bearing surfaces configured for relative angular sliding movement.

The male gear may comprise a gear body adapted to receive drive from the input, the gear body comprising a toothed formation providing the male gear teeth, and wherein there are two of said spherical bearings disposed one to each side of the toothed formation.

The male gear body may comprise a central section and two side sections, one on each side of the central section, the central section defining the toothed formation, and the two side sections each supporting a respective one of the two spherical bearings.

The top land of each of the male gear teeth may be curved, reflecting the barrel configuration of the male gear.

The curvature of the outer convex spherical bearing surface of each inner bearing member may match the curvature of the top land of each tooth of the male gear. The outer convex spherical bearing surfaces of the two inner bearing members and the curvature of the top land of each tooth of the male gear may cooperate to describe an arc which is concentric with the line of meshing contact between the male and female gears.

The female internal gear may be integral with the hub.

The hub may comprise a hub body of annular construction defining a central opening adapted to receive the male gear.

The hub body may comprises a central section and two side sections on opposed sides of the central section, with the central section and the two side sections extending circumferentially around the central opening, the central section defining an internal toothed formation which defines the female gear teeth, each side section being mounted on the respective spherical bearing.

Each side section may define a circumferential internal shoulder adapted to receive the outer bearing member of the respective spherical bearing.

The arrangement featuring the male and female gears with the female gear being supported on the male gear by spherical bearings provides a joint between the hub and the shaft upon which the male gear is mounted, with the joint in effect mounting the hub on the shaft and permitting lateral articulation of the roller gear with respect to the shaft The joint accommodates angular movement between the male and female gears while maintaining meshing engagement therebetween throughout the range of angular movement. This in turn provides for the angular movement between the roller gear and the shaft, while maintaining meshing engagement between the male and female gears throughout the range of angular movement, thereby ensuring transmission of drive from the power system to the roller gear throughout the range of angular movement.

The drive system may further comprise an actuator operable for selectively engaging the output with the aircraft landing gear.

The actuator may be operable while the aircraft is in motion. Following landing of the aircraft, the actuator may be operated to move the drive system into driving engagement with the aircraft landing gear, thereby allowing taxing of the aircraft using the drive system. During departure, the drive system may be engaged driving engagement with the aircraft landing gear for taxiing and thereafter disengaged during take-off.

According to a second aspect of the invention there is provided a mechanical transmission comprising an input, an output and a gear mechanism operably coupling the input and output to transmit drive from the input to the output, the gear mechanism being configured to accommodate misalignment between the input and output.

The gear mechanism may be provided with any one or more of the features referred to above in relation to the drive system according to the first aspect of the invention.

According to a third aspect of the invention there is provided a mechanical transmission comprising an input, an output and a gear mechanism operably coupling the input and output to transmit drive from the input to the output, the gear mechanism being configured to accommodate misalignment between the input and output, the gear mechanism comprising a male external gear and a female internal gear in meshing engagement about the external male gear, the male gear being of barrel configuration and the female gear being of straight configuration, the male gear comprises gear teeth presenting a constant involute curve.

More particularly, the male gear may comprise gear teeth presenting a rhomboidal lead profile with constant involute profile along the full length of the male gear.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings which illustrate the features of the mechanical transmission: In the drawings:

FIG. 1 is a schematic perspective view of a drive system for an aircraft, the drive system being selectively moveable into and out of driving engagement with the landing gear of the aircraft;

FIG. 2 is a schematic view of the drive system out of driving engagement with the landing gear of the aircraft;

FIG. 3 is a schematic view of the drive system in driving engagement with the landing gear of the aircraft;

FIG. 4 is schematic perspective view of part a drive system, illustrating in particular a mechanical transmission, with a portion thereof cut-away to reveal a gear mechanism within the mechanical transmission;

FIG. 5 is an end view of part of the drive system, illustrating in particular an output hub configured to provide a roller gear;

FIG. 6 is a schematic perspective view of the output hub;

FIG. 7 is a cross-section on line 7-7 of FIG. 5, with the roller gear shown in a normal condition;

FIG. 8 is a view similar to FIG. 7, but with the roller gear shown in a condition in which it has articulated laterally to accommodate some misalignment;

FIG. 9 is a schematic fragmentary sectional view, on a larger scale, showing the output hub supported on spherical bearings to accommodate angular movement of the roller gear;

FIG. 10 is a schematic side view of the output hub illustrating a range of articulations of the roller gear from the normal condition to both slides thereof;

FIG. 11 is a schematic perspective view of a male gear forming part of the gear mechanism shown in FIG. 4;

FIG. 12 is an end view of the male gear;

FIG. 13 is a longitudinal cross-section on line 13-13 of FIG. 12;

FIG. 14 is a plan view of the profile of a gear tooth of the male gear;

FIG. 15 is an end view of the body of the output hub shown in FIG. 6; and

FIG. 16 is a longitudinal cross-section on line 16-16 of FIG. 15.

In the drawings like structures are referred to by like numerals throughout the several views. The drawings shown are not necessarily to scale, with emphasis instead generally being placed upon illustrating the principles of the present invention.

The figures depict an embodiment of the invention. The embodiment illustrates certain configurations; however, it is to be appreciated that the invention can take the form of many configurations, as would be obvious to a person skilled in the art, whilst still embodying the present invention. These configurations are to be considered within the scope of this invention.

### DESCRIPTION OF EMBODIMENT

The embodiment is directed to a drive system 10 for an aircraft, operable for selectively enabling ground movement, and in particular taxiing movement, of the aircraft without requiring the aircraft to be moved by a ground vehicle.

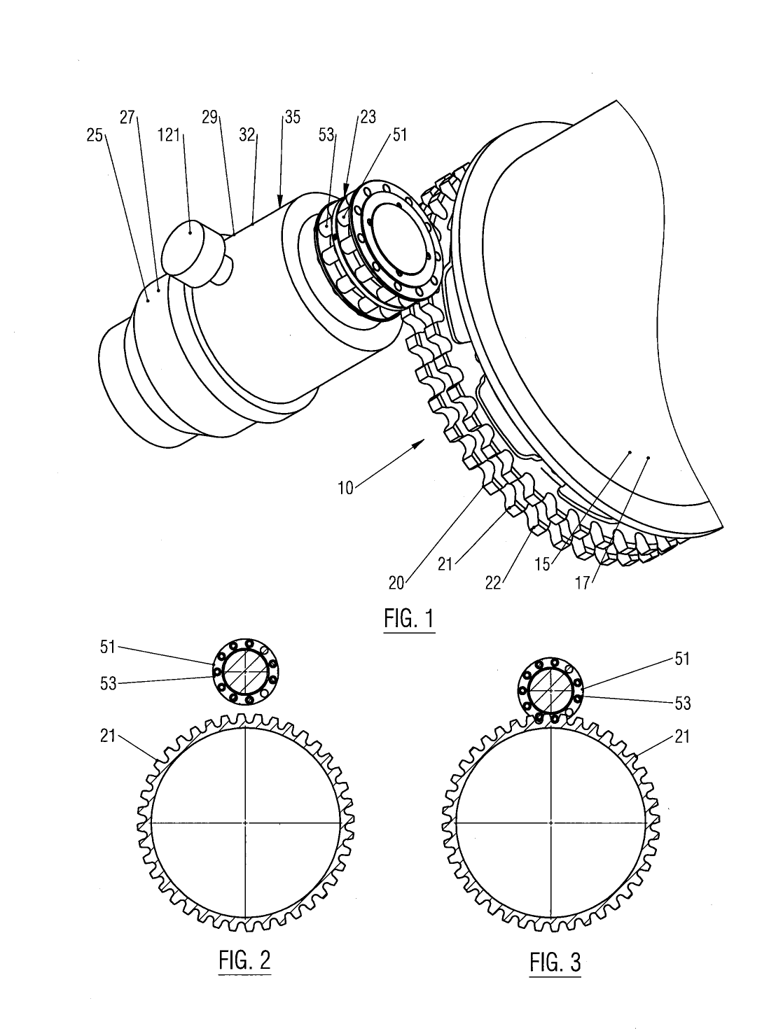

The drive system 10 is selectively operable to impart rotational drive to landing gear 13 of the aircraft. Referring in particular to FIGS. 1, 2 and 3, the drive system 10 delivers rotation and torque to a landing wheel 15 forming part of the aircraft landing gear 13. The landing wheel 15 includes a wheel rim 17 onto which a tyre is fitted. Only the rim 17 of the landing wheel 15 is shown in the drawings. In the arrangement shown, there is a single landing wheel 15, however the arrangement can be configured to drive aircraft landing gear having dual landing wheels, as would be understood by a person skilled in the art.

The drive system 10 comprises means 20 drivingly coupled to the wheel rim 17 to receive rotation and torque, and to transmit that rotation and torque to the wheel rim 17. In this embodiment, the means 20 comprises sprocket means 21 fixed onto the wheel rim 17. In the arrangement shown, the sprocket means 21 comprises two sprockets 22 disposed in side-by-side relation with their sprocket teeth in alignment. Each sprocket 22 is configured as a ring gear. Other arrangement are contemplated, including a sprocket means 21 comprising a single sprocket 22.

The drive system 10 further comprises a mechanical transmission 23 for delivering rotational drive to the landing gear 13 of the aircraft for driving the landing wheel 15.

The drive system 10 still further comprises a power system 25 providing mechanical power to drive the mechanical transmission 23. The power system 25 may comprise a power source 27 such as an electric motor. The electric motor 27 may be powered from an auxiliary power unit (APU) onboard the aircraft. The power system 25 may further comprise a gearbox 29 driven by the electric motor 27. The gearbox 29 has an output drive shaft 31 and a gearbox housing 32 from which the output drive shaft extends. The output drive shaft 31 is provided with splines 33. With this arrangement, the power system 25 delivers mechanical power via the output drive shaft 31.

The drive system 10 is integrated into an assembly 35 mounted on the aircraft in conjunction with the landing gear 13. The assembly 35 includes gearbox housing 32.

The mechanical transmission 23 comprises an input 41 for receiving drive from the power system 25, an output 43 for delivering drive to the landing gear 13 for driving the landing wheel 15, and a gear mechanism 45 operably coupling the input 41 and output 43 to transmit drive from the input to the output.

The input 41 of the mechanical transmission 23 receives mechanical power in the form of torque (drive) from the power system 25 via the output drive shaft 31. In this embodiment, the input 41 of the mechanical transmission 23 comprises the output drive shaft 31 of the gearbox 29. In other words, there is a common shaft 50 which provides both the output drive shaft 31 of the gearbox 29 and the input 41 of the mechanical transmission 23. The common shaft 50 incorporates the external splines 33.

The gear mechanism 45 is configured to accommodate angular misalignment between the input 41 and output 43.

With this arrangement, the mechanical transmission 23 is operable to allow freedom of movement to accommodate some angular displacement between the input 41 and output 43. This angular displacement between the input 41 and output 43 may, for example, arise as a consequence of loadings and wheel deflection imposed upon the landing gear 13 during take-off and landing of the aircraft, particularly at times when the landing wheel moves into and out of contact with the ground surface. Typically, angular misalignments of up to about +/−3 degrees are encountered.

In this embodiment, however, the mechanical transmission 23 is operable to accommodate angular misalignment up to a maximum of about +/−5 degrees. More particularly, in this embodiment the mechanical transmission 23 is operable accommodate angular misalignment up to about a maximum of about +/−5 degrees during low cycles 432,000 revs @ 2700 Nm and high cycles 4.8×10⁸ revs @ 560 Nm of operation.

In the arrangement shown, the output 43 comprises a hub 51 configured as a roller gear 53 for meshing engagement with the sprocket means 21 drivingly coupled to the landing wheel 15 of the aircraft landing gear 13. In this way, rotation of the hub 51 can be transferred to the wheel 15 of the aircraft landing gear 13 to impart drive thereto.

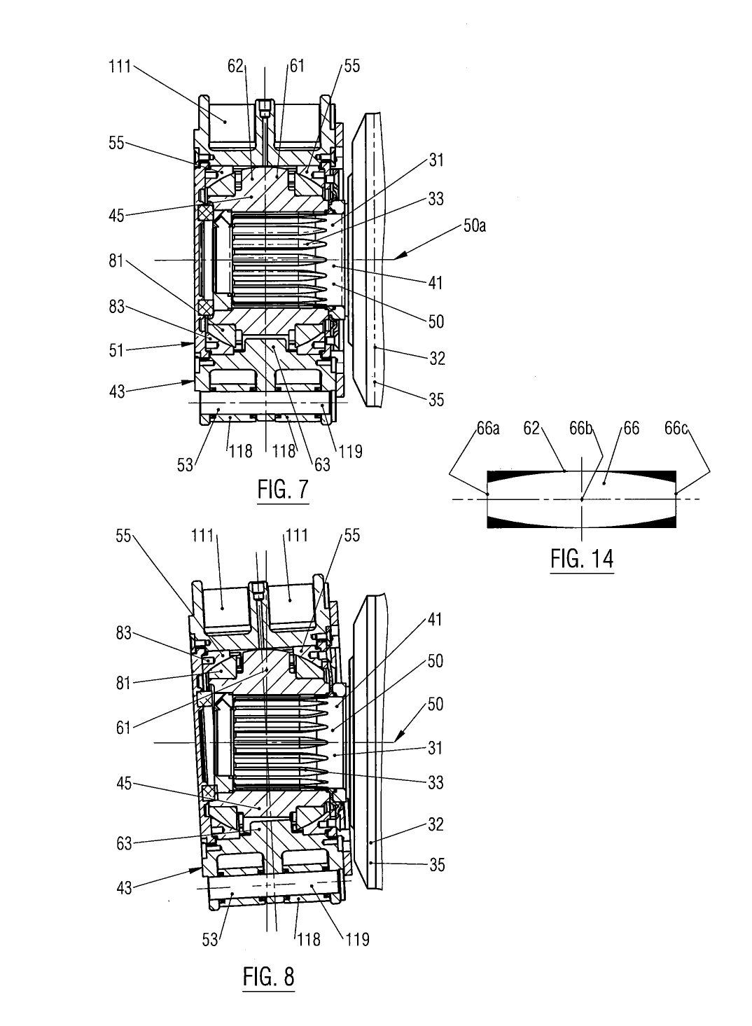

The hub 51 is supported on spherical bearings 55 which allow lateral angular displacement of the roller gear 53. The lateral angular displacement of the roller gear 53 is back and forth about an axis normal to the axis of rotation of common shaft 50, as depicted schematically in FIG. 10. The axis of rotation of common shaft 50 is identified in the drawings by reference 50a. The roller gear 53 is depicted in a normal condition in FIG. 7 and articulated into an angularly displaced condition in FIG. 8.

The gear mechanism 45 comprises a male external gear 61 and a female internal gear 63 in meshing engagement with each other, with the female internal gear 63 being mounted upon the external male gear 61 and all gear teeth concurrently in mesh.

The male external gear 61 is adapted to be mounted on the common shaft 50 which provides both the output drive shaft 31 of the power system 25 and the input 41 of the mechanical transmission 23.

The roller gear 53 is supported for angular displacement relative to the male external gear 61. In the arrangement shown, the hub 51 is rotatably supported by way of the spherical bearings 55, thereby accommodating lateral angular displacement of the roller gear 53.

The female internal gear 63 is integral with the hub 51.

The male gear 61 comprises external gear teeth 62 of barrel configuration and the female gear 63 comprises internal gear teeth 64 of straight configuration. This arrangement facilitates angular movement between the male and female gears 61, 63 while maintaining meshing engagement therebetween throughout the range of angular movement.

More particularly, the male gear teeth 62 present an involute curve. Specifically, in this embodiment, the male gear 61 comprises gear teeth 62 presenting a rhomboidal lead profile with constant involute profile. The rhomboidal lead profile can be seen in FIG. 14, which is a plan view of the profile of a male gear tooth 62.

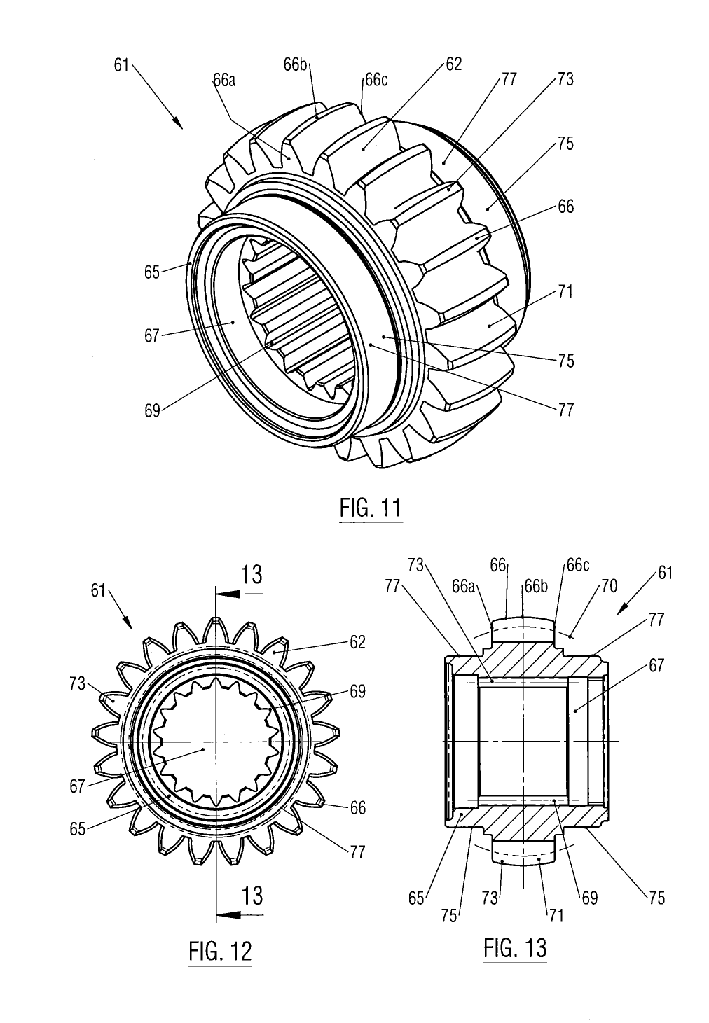

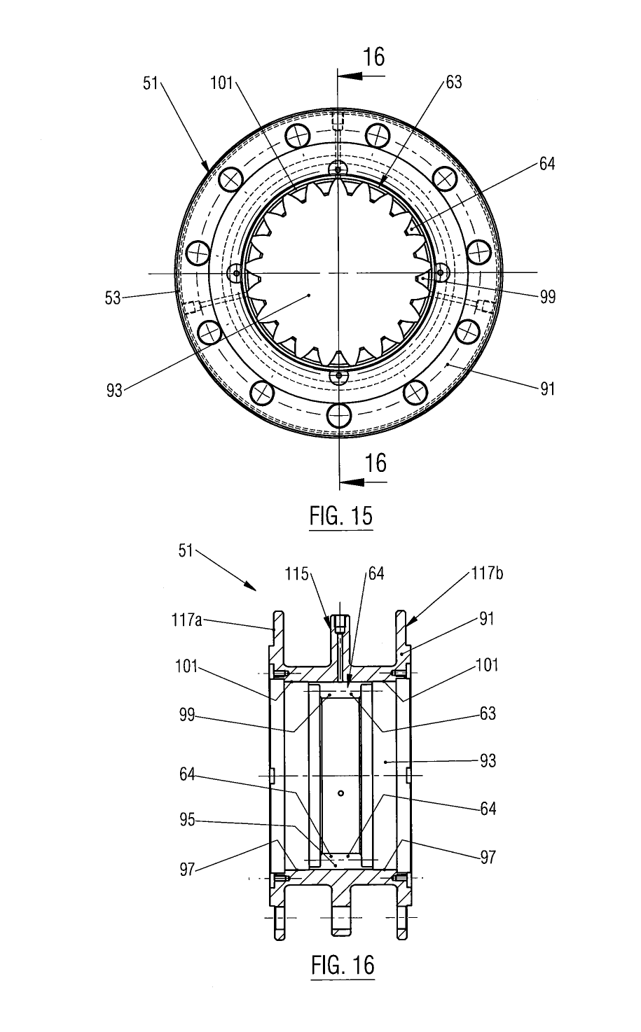

The external gear teeth 62 are of barrel configuration in the sense that the top land 66 of each tooth is curved rather than straight. In particular, the top land 66 of each tooth is longitudinally convex, as best seen in FIGS. 11 and 13. With this arrangement, the top land 66 of each tooth progressively ascends from a radially innermost point 66a adjacent one end of the tooth to a radially outermost point 66b at the centre and then progressively descends to a further radially innermost point 66c adjacent the opposed end of the tooth.

The internal gear teeth 64 are of straight configuration in the sense that the top land of each tooth is straight rather than being curved.

The arrangement facilitates full meshing contact between the male and female gears 61, 63 throughout the full specified range of misalignment between the input 41 and the output 43 (being up to 5 degrees in this embodiment). The meshing contact between the male and female gears 61, 63 is along a line of meshing contact which is depicted schematically in FIG. 13 and identified by reference numeral 70. The meshing contact between the male and female gears 61, 63 is always full meshing contact in the sense that contact is present to the same extent along the line of meshing contact 70 throughout the full specified range of articulation of the roller gear 53 with respect to the common shaft 50.

The male gear 61 comprises a gear body 65 having a central bore 67 adapted to receive the common shaft 50 and internal splines 69 within the central bore 67 adapted to mate with the external splines 33 on the common shaft 50, whereby the male gear 61 is rotatable in unison with the common shaft 50. In this way, drive delivered by way of the output drive shaft 31 of the power system 25 is transmitted to the male gear 61.

The gear body 65 comprises a central section 71 defining a toothed formation 73 which provides the gear teeth 62, and two side sections 75, one on each side of the central section 71. Each side section 75 defines an circumferential external shoulder 77.

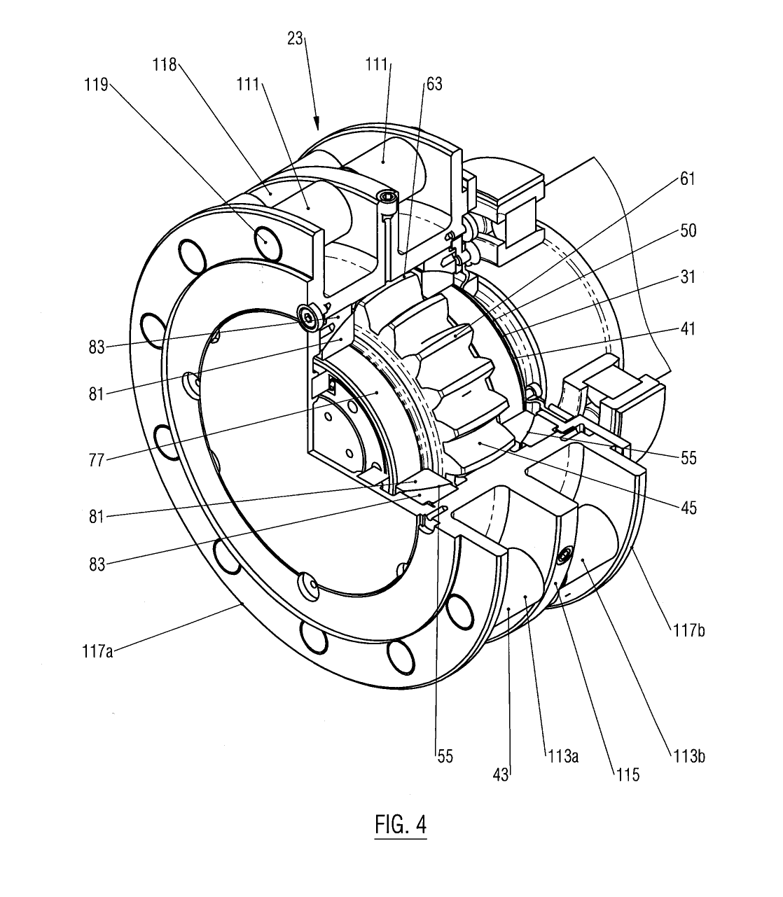

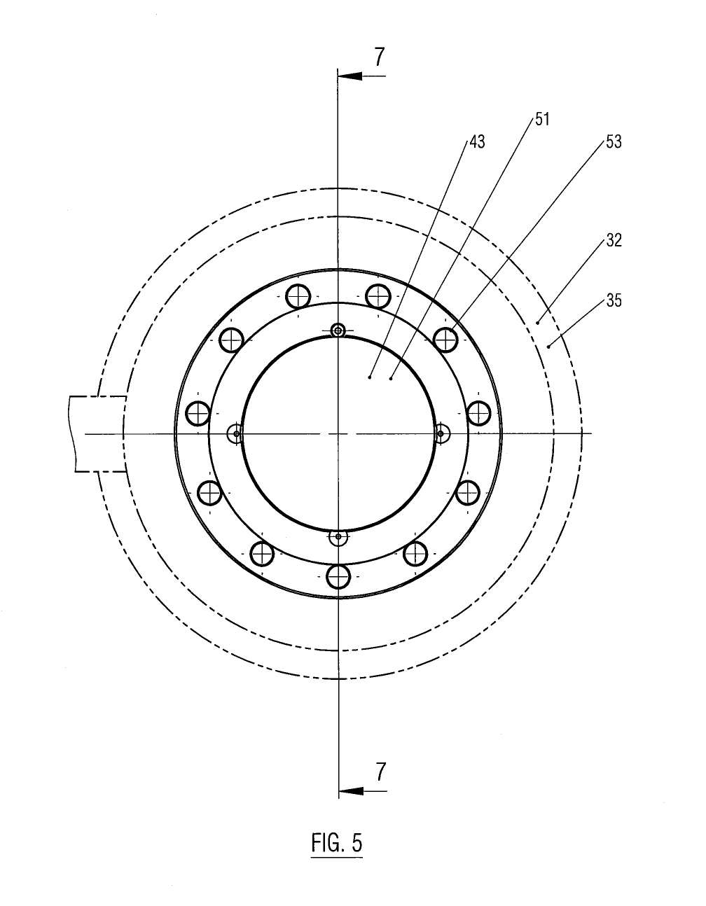

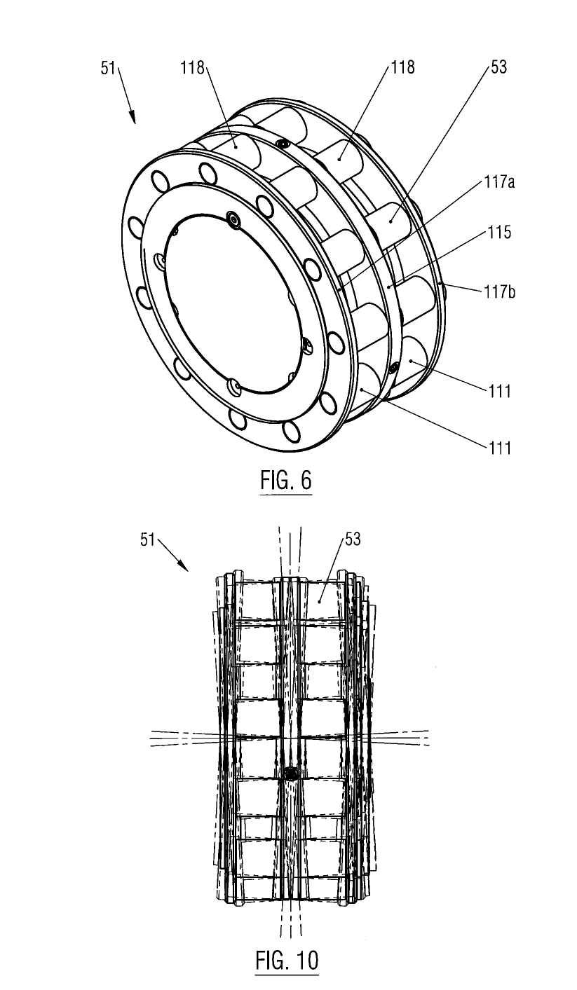

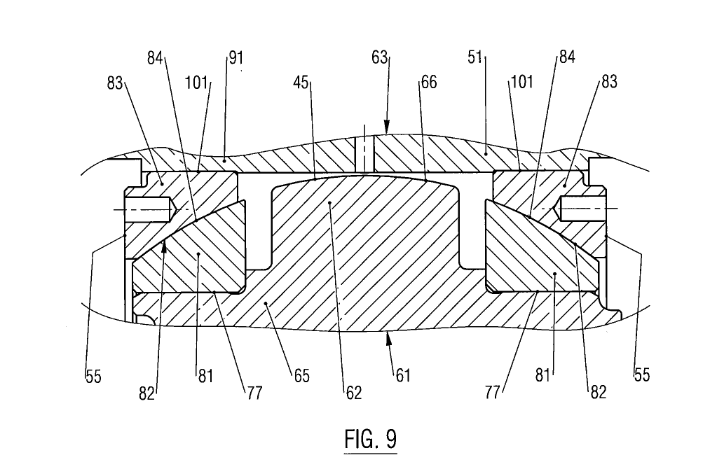

The circumferential external shoulders 77 on the male gear 61 support the spherical bearings 55, as shown in FIGS. 4, 7, 8 and 9. In this way, the roller gear 53 is rotatably supported on the male gear 61 by way of the spherical bearings 55 to provide for the angular movement. With this arrangement, the roller gear 53 is, in effect rotatably supported (indirectly) on the common shaft 50 to provide for the angular movement.

Each spherical bearing 55 comprises an inner bearing member 81 having an outer convex spherical bearing surface 82, and an outer bearing member 83 having an inner concave spherical bearing surface 84, with the outer and inner spherical bearing surfaces 82, 84 configured for relative angular sliding movement.

The two spherical bearings 55 are configured to cooperate one with the other to accommodate angular movement between the meshing male external gear 61 mounted on the common shaft 50 and the female internal gear 63 integral with the hub 51. In other words, the two spherical bearings 55 are operable to accommodate angular movement between the output drive shaft 31 of the gearbox 29 and the roller gear 53 to which drive is transmitted through the gear mechanism 45. The extent of angular movement which can be accommodated by the two spherical bearings 55 is, in this embodiment, up to about a maximum of about +/−5 degrees.

In this embodiment, the curvature of the outer convex spherical bearing surface 82 of each inner bearing member 81 matches the curvature of the top land 66 of each tooth of the male gear 61, as can be seen in FIGS. 7, 8 and 9. In this way, the outer convex spherical bearing surfaces 82 of the two inner bearing member 81 and the curvature of the top land 66 of each tooth of the male gear 61 cooperate to describe an arc which is concentric with the line of meshing contact 70 between the male and female gears 61, 63

The spherical bearings 55 feature integral surface lubrication retention for the outer and inner spherical bearing surfaces 82, 84.

The hub 51 is configured as roller gear 53 for meshing engagement with the sprocket means 21.

More particularly, the hub 51 comprises a hub body 91 of annular construction defining a central opening 93 adapted to receive the male gear 61. The hub body 91 comprises a central section 95 and two side sections 97 on opposed sides of the central section, with the central section 95 and the two side sections 97 extending circumferentially around the central opening 93. The central section 95 defines an internal toothed formation 99 which defines the female gear 63 featuring the internal gear teeth 64. Each side section 97 defines n circumferential internal shoulder 101 adapted to receive the outer bearing member 83 of the respective spherical bearing 55.

With this arrangement, the hub 51 can be mounted on the male gear 61. The male gear 61 is received within the central opening 93 of the hub 51, with the external gear teeth 62 of the male gear 61 in meshing engagement with internal teeth 64 of the female gear 63. The hub 51 is supported on the male gear 61 by the spherical bearings 55. Each spherical bearing 55 is fitted between the male gear 61 and the hub body 91, with the inner bearing member 81 seated against the respective circumferential external shoulder 77 of the gear body 65 of the male gear 61 and the outer bearing member 83 seated against the counterpart circumferential internal shoulder 101 of the hub body 91 of the hub 51.

This arrangement thus provides a joint 110 between the hub 51 and the common shaft 50, with the joint in effect mounting the hub on the common shaft and permitting lateral articulation of the roller gear 53 with respect to the common shaft 50.

Joint 110 accommodates the prescribed angular movement between the male and female gears 61, 63 while maintaining meshing engagement therebetween throughout the range of angular movement. This in turn provides for the prescribed angular movement between the roller gear 53 and the common shaft 50, while maintaining meshing engagement between the male and female gears 61, 63 throughout the range of angular movement, thereby ensuring transmission of drive from the power system 25 to the roller gear 53 throughout the range of angular movement.

The feature configuring the hub 51 as roller gear 53 comprises a plurality of circumferentially arranged rollers 111 adapted for meshing engagement with the sprocket means 21. In this embodiment, the rollers 111 are arranged in two sets 113, with each set adapted to cooperate with a respective one of the two sprockets 22 defining the sprocket means 21.

The hub body 91 comprises three axially spaced annular flanges, being a central annular flange 115 and two end annular flanges 117, with one set 113a of rollers 111 supported between the central flange 115 and one end flange 117a, and the other set 113b of rollers 111 supported between the central flange 115 and the other end flange 117b. Each roller 111 comprises a roller element 118 configured as a roller sleeve rotatably supported on a roller pin 119 fixed at its ends between the central flange 115 and the respective end flange 117, as is known practice in relation to roller gears.

The roller gear 53 is adapted for meshing engagement with the sprocket means 21, with the rollers 111 sequentially engaging with corresponding teeth in the respective sprockets 22 to transmit rotation and torque from the roller gear 53 to the sprocket means 21.

In this embodiment, the teeth of the male gear 61 and female gear 63 respectively can be cut using a five-axis machine, as would be understood by a person skilled in the art.

As mentioned above, the drive system 10 is integrated into the assembly 35 mounted on the aircraft in conjunction with the landing gear 13. The assembly 35 is separate from the sprocket 21 drivingly coupled to the landing wheel 15 of the aircraft landing gear 13

In this embodiment, the drive system 10 further comprises an actuator 121 operable for selectively moving the assembly 35 into and out of driving engagement with the landing gear 13 of the aircraft. More particularly, the actuator 121 operable for selectively moving the assembly 35 into and out of a condition in which the roller gear 53 defined by the hub 51 is in meshing engagement with the sprocket means 21. In this way, when the roller gear 53 is in meshing engagement with the sprocket means 21, rotation of the hub 51 is transferred to the wheel 15 of the aircraft landing gear 13 to impart drive thereto. The roller gear 53 defined by the hub 51 is shown out of meshing engagement with the sprocket means 21 in FIG. 2 and in meshing engagement with the sprocket means 21 in FIG. 3.

The actuator 121 may be operable while the aircraft is in motion.

Following landing of the aircraft, the drive system 10 may be engaged, thereby allowing taxing of the aircraft using the drive system. To engage the drive system 10, the actuator 121 is operated to move the assembly 35 into driving engagement with the landing gear 13 of the aircraft; that is, to move the hub 51 is in meshing engagement with the sprocket means 21. The arrangement is such that this engagement can be effected while the landing wheel 15 is rotating.

During departure aircraft, the drive system 10 may be engaged for taxiing and thereafter disengaged during take-off. To disengage the drive system 10, the actuator 121 is operated to move the assembly 35 out driving engagement with the landing gear 13 of the aircraft; that is, to move the hub 51 out of meshing engagement with the sprocket means 21. The arrangement is such that this disengagement can be effected while the landing wheel is rotating.

As mentioned above, the arrangement provides joint 110 between the hub 51 and the common shaft 50, with the joint in effect mounting the hub on the common shaft. The joint 110 permits the roller gear 53 to articulate with respect to the common shaft 50 to assume a condition in which the axis of rotation of the roller gear 53 is in effect parallel to the axis of rotation of the sprocket means 21. When the roller gear 53 does articulate with respect to the common shaft 50, it moves out of axial alignment with the common shaft and is angularly displaced with respect thereto. The condition in which the roller gear 53 is in axial alignment with the common shaft 50 is referred to as the normal condition of the roller gear. FIG. 10 depicts a range of articulations of the roller gear 53 from the normal condition to both slides thereof;

With this arrangement, the roller gear 53 is able to respond to misalignment between the roller gear 53 and the sprocket means 21. In normal circumstances, the drive system 20 is configured such that the axes of rotation of the roller gear 53 and the sprocket means 21 would be parallel to readily facilitate meshing engagement between the roller gear 53 and the sprocket means 21 for transmission of drive. However, this parallel relationship can be disrupted (with the result that the roller gear 53 and the sprocket means 21 become misaligned), as a consequence of, for example, loadings and wheel deflection imposed upon landing gear 13 during take-off and landing of the aircraft, particularly at times when the landing wheel 15 moves into and out of contact with the ground surface. In operation, as the roller gear 53 moves into meshing engagement with the sprocket means 21, it is able to respond to any misalignment between the roller gear and the sprocket means by articulating from its normal condition (as depicted in FIG. 7) to assume an articulated condition (for example as depicted in FIG. 8) in which the axis of rotation of the roller gear is in effect parallel to the axis of rotation of the sprocket means to thereby achieve effective driving engagement with the sprocket means. In this way, the roller gear 53 has a self-alignment feature. In other words, the roller gear 53 moves from a normal condition in which it is axially aligned with the common shaft 50 into an articulated condition in which it is no longer aligned (it now being misaligned) with the common shaft and instead has its axis of rotation parallel to the axis of rotation of the sprocket means 21. In this way, initial misalignment between the roller gear 53 and the sprocket means 21 can be accommodated.

Gear teeth featuring a rhomboidal lead profile with constant involute profile, enables the hub 51 to articulate to effect self-alignment between the roller gear 53 and the sprocket means 21 to a maximum of +/−5 degree in this embodiment. During self-alignment, the joint 110 rotates to ensure that the axis of rotation of the roller gear 53 is parallel to the axis of rotation of the sprocket means 21. Throughout the range of angular rotation (angular displacement) of the roller gear 53 relative to the common shaft 50, full meshing contact between the male and female gears 61, 63 is retained, thereby ensuring full transmission of drive from the power system 25 to the roller gear 53 and onto the sprocket means 21.

Modifications and variations such as would be apparent to the skilled addressee are considered to fall within the scope of the present invention. By way of example, in the embodiment described and illustrated, the male gear 61 is mounted on common shaft 50, with the internal splines 69 of the male gear mating with the external splines 33 on the common shaft 50, and the hub 51 mounted on the male gear. Other arrangements are contemplated.

One such other arrangement may feature the mechanical transmission 23 having an input 41 which is separated from the output drive shaft 31 of the power system 25 and which is adapted to be coupled to the output drive shaft 31. In such an arrangement, the male gear 61 may be formed integrally with a shaft which functions as the input shaft 41 of the mechanical transmission 23. Further, with such an arrangement, the spherical bearings 55 may be fitted between the input shaft 41 (with which the male gear 61 is integral) and the hub 51, rather than between the male gear 61 and the hub 51 as is the case with the first embodiment.

In another arrangement contemplated, the sprocket means 21 may comprise a single sprocket rather than two sprockets in side-by-side relation as is the case in the embodiment described and illustrated. With such an arrangement, the roller gear 53 would require only one set of circumferentially spaced rollers 111 for meshing engagements with the single sprocket.

The present disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While a preferred embodiment of the invention has been described and illustrated, it is clear that the invention is not so limited. Numerous modifications, changes, variations, substitutions, and equivalents will occur to those skilled in the art having the benefit of this disclosure without departing from the spirit and scope of the present invention as defined by the following claims.

Reference to positional descriptions, such as “inner”, “outer”, “upper”, “lower”, “top” and “bottom”, are to be taken in context of the embodiment depicted in the drawings, and are not to be taken as limiting the invention to the literal interpretation of the term but rather as would be understood by the skilled addressee.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A drive system for an aircraft, the drive system comprising a power system and a mechanical transmission for delivering rotational drive to landing gear of the aircraft, the mechanical transmission comprising an input for receiving drive from the power system, an output for delivering drive to the landing gear and a gear mechanism operably coupling the input and output to transmit drive from the input to the output, the gear mechanism being configured to accommodate misalignment between the input and output.

2. The drive system according to claim 1, wherein the power system comprises a power source.

3. The drive system according to claim 2, wherein the power system further comprises a gearbox for transmitting drive from the power source to the input of the mechanical transmission.

4. The drive system according to claim 1, wherein the gear mechanism is configured to accommodate angular misalignment between the input and output to an extent up to about 5 degrees.

5. The drive system according to claim 1, wherein the gear mechanism comprises a male external gear and a female internal gear in meshing engagement about the external male gear.

6. The drive system according to claim 5 wherein the male gear is of barrel configuration and the female gear is of straight configuration to facilitate angular movement between the male and female gears which maintaining meshing engagement therebetween.

7. The drive system according to claim 5, wherein male gear comprises gear teeth presenting an involute curve profile.

8. The drive system according to claim 7, wherein the involute curve is constant along the full length of the external male gear.

9. The drive system according to claim 6, wherein the male gear comprises gear teeth presenting a rhomboidal lead profile with constant involute profile.

10. The drive system according to claim 1, wherein the output comprises a roller gear adapted to be drivingly coupled to the landing gear.

11. The drive system according to claim 10, wherein the roller gear is be adapted to be drivingly coupled to a landing wheel of the landing gear, wherein there is provided a sprocket means drivingly coupled to the landing wheel, and wherein the roller gear is adapted for meshing engagement with the sprocket means

12. The drive system according to claim 10, wherein the output further comprises a hub incorporating the roller gear.

13. The drive system according to claim 12, wherein the hub is supported on spherical bearings allowing angular displacement of the roller gear.

14. The drive system according to claim 13, wherein each spherical bearing comprises an inner bearing member having an outer convex spherical bearing surface, and an outer bearing member having an inner concave spherical bearing surface, with the outer and inner spherical bearing surfaces configured for relative angular sliding movement.

15. The drive system according to claim 13, wherein male gear comprises a gear body adapted to receive drive from the input, the gear body comprising a toothed formation providing the male gear teeth, and wherein there are two of said spherical bearings disposed one to each side of the toothed formation.

16. The drive system according to claim 15, wherein the male gear body comprises a central section and two side sections, one on each side of the central section, the central section defining the toothed formation, and the two side sections each supporting a respective one of the two spherical bearings.

17. The drive system according to claim 6, wherein meshing contact between the male and female gears is along a line which is arcuate, the line corresponding to the range of angular movement of the output available to accommodate angular misalignment, wherein the top land of each of the male gear teeth is curved, reflecting the barrel configuration of the male gear, wherein the curvature of the outer convex spherical bearing surface of each inner bearing member matches the curvature of the top land of each tooth of the male gear, and wherein the outer convex spherical bearing surfaces of the two inner bearing members and the curvature of the top land of each tooth of the male gear cooperate to describe an arc which is concentric with the line of meshing contact between the male and female gears.

18. The drive system according to claim 12, wherein the female internal gear is integral with the hub.

19. The drive system according to claim 12, wherein the hub comprises a hub body of annular construction defining a central opening adapted to receive the male gear.

20. A mechanical transmission comprising an input, an output and a gear mechanism operably coupling the input and output to transmit drive from the input to the output, the gear mechanism being configured to accommodate misalignment between the input and output.

21. A mechanical transmission comprising an input, an output and a gear mechanism operably coupling the input and output to transmit drive from the input to the output, the gear mechanism being configured to accommodate misalignment between the input and output, the gear mechanism comprising a male external gear and a female internal gear in meshing engagement about the external male gear, the male gear being of barrel configuration and the female gear being of straight configuration, the male gear comprises gear teeth presenting a constant involute curve along the full length of the external male gear.
